(19) United States
(12) Patent Application Publication
(10) Pub. No.: US 2005/0164621 A1
(43) Pub. Date: Jul. 28, 2005

(54) Arrangement and method for division of animals into groups and transfer of groups of animals to a stunning apparatus

(75) Inventor: Leif Christensen, Vaerloese (DK)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SLAGTERIERNES FORSKNINGSINSTITUT, Roskilde, Dk (DK)

(21) Appl. No.: 10/509,195

(22) PCT Filed: Mar. 26, 2003
(86) PCT No.: PCT/DK03/00203

(30) Foreign Application Priority Data
Mar. 27, 2002 (DK) PA 2002 00465

(51) Int. Cl. A22B 3/00

(52) U.S. Cl. 452/57

(57) ABSTRACT

Arrangement for division of animals into groups and transfer of groups of animals to a stunning apparatus. An oblong corridor section in which animals can be driven from an entrance end to an exit end. A division gate is provided in the corridor section between the entrance end and the exit end, in such a way that the corridor area between the division gate and the exit end has room for a number of animals corresponding to a group size. A transfer section is placed at the exit of the corridor section, having room for a number of animals corresponding to the group size.

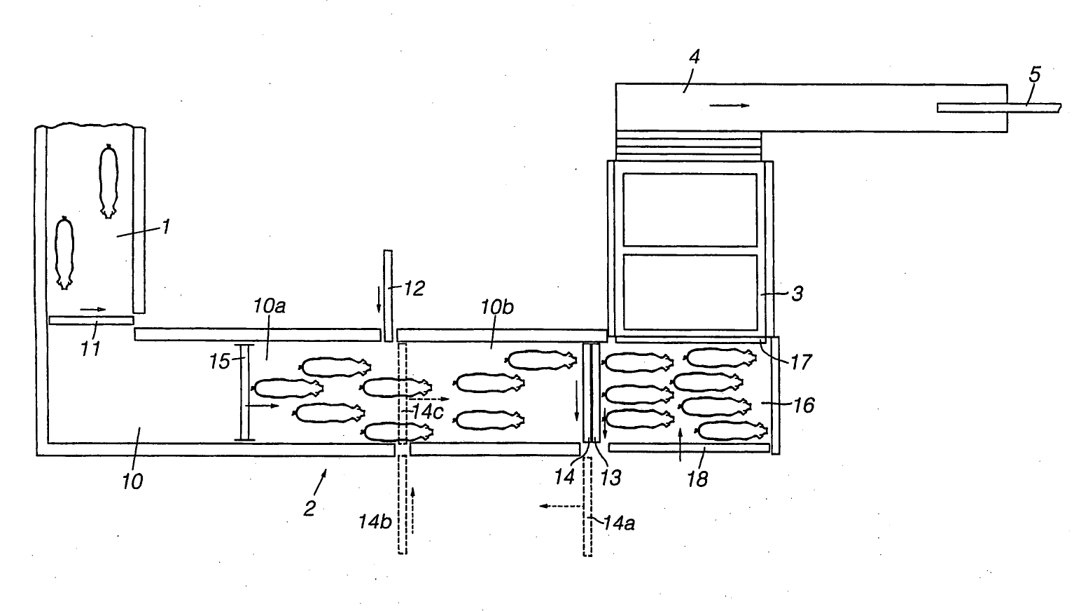

The present invention relates to an arrangement and a method for division of animals into groups and transfer of groups of animals to a stunning apparatus.

Stunning of especially slaughter pigs in groups by means of CO₂ has gained a footing in the slaughterhouses in recent years because this method provides a lenient handling of the animals. From the pen area a flock of animals is driven into a corridor, in which the flock is divided into groups of a size, which matches the box size of the stunning apparatus. Then the groups are driven one by one into the boxes of the stunning apparatus, as these get ready to receive the animals. The boxes used can for instance hold a group of animals of 3-10 slaughter pigs, e.g. a group of 7-8 or 5 animals, obtained by division of a flock of 15 animals into 2 or 3 groups.

In a well-known division system a transverse sliding gate is placed in front of the last corridor section before the entrance to the stunning apparatus, which gate during the division process is partially opened so that only one animal at a time can pass. The gate is closed when a number of animals corresponding to the group size have passed. Then the entrance to the stunning apparatus is opened, and the isolated group of animals is driven into a vacant stunning box by means of a movable wall, which is moved towards the entrance of the stunning apparatus from the side wall furthest away from the entrance. When the animals have been driven into the box and the movable wall has been returned to its starting position, the sliding gate can be opened again, allowing a new group of animals to pass, whereupon the method is repeated for the new group.

A drawback by this system is that the division of animals into groups can only be started when the movable wall is back in its starting position, which limits the capacity of the stunning apparatus.

Other well-known systems for division of animals in groups and transfer of the groups to a stunning apparatus have similar limitations in the handling of the animals.

The purpose of the present invention is to provide an arrangement for division of animals into groups and transfer of groups of animals to a stunning apparatus, by >which arrangement the process of division and transfer of a group of animals into the stunning apparatus are flexible and efficient.

The arrangement according to the invention is characterized in that it comprises an oblong corridor section in which animals can be driven from an entrance end to an exit end, that it has a division gate in the corridor section between the entrance end and the exit end, which gate is placed in such a way that the corridor area between the division gate and the exit end has room for a number of animals corresponding to the group size, and that a transfer section is placed in continuation of the corridor section at the exit end of the section, which transfer section can hold a number of animals corresponding to the group size and which section has a connection with the entrance to the stunning apparatus.

In the arrangement according to the invention the division process can be started as soon as the passage to the transfer section has been closed behind a driven-in group of animals or perhaps earlier, especially in arrangements using a travelling sliding or travelling elevating gate in the corridor area between the division gate and the exit end. In this way the division process can be started long before the animals in the transfer section have been transferred to a stunning box and the reception state of the transfer section has been re-established. This gives a higher degree of utilization of the stunning apparatus, and the division system has better time to divide a flock of animals into groups, which can result in a significant improvement of the handling of the animals.

Advantageous embodiments of the arrangement according to the invention are stated in claims 2-14.

The method according to the invention for division of animals into groups and transfer of groups of animals to a stunning apparatus is characterized in
a) that animals are driven in an oblong corridor section from an entrance end towards an exit end and past an open division gate, which is placed between the entrance end and the exit end, the division gate being placed in such a way that the corridor area between the close division gate and the exit end has room for a number of animals corresponding to the group size,
b) that the division gate is closed when a number of animals corresponding to the group size have passed,
c) that the group of animals is driven into a transfer section, placed in continuation of the corridor section at the exit end of the section when the transfer section is ready to receive a group of animals, which transfer section has room for a number of animals corresponding to the group size and has a connection with the entrance to the stunning apparatus,
d) that the access from the corridor section to the transfer section is closed,
e) that the group of animals in the transfer section is driven into the stunning apparatus when this is ready to receive a group of animals, and
f) that the process steps a) to e) are repeated as long as there are animals in the corridor area between the entrance end and the division gate, the division gate being opened between each cycle.

Preferred embodiments of the method according to the invention are stated in claims 16-19.

The arrangement and method according to the invention are used especially for division and transfer of slaughter pigs and sheep (incl. lambs), e.g. for flocks of animals of 15 individuals, which are driven in from the pen area of the slaughterhouse for division into groups of 7-8 or 5 animals and transferred in groups to a stunning apparatus. The arrangement and method can also be used for division and transfer of cattle, whereby a group of animals can be as few as one individual handled at a time by animals weighing several hundred kg, as it may be appropriate to handle such big animals one by one when they are to be driven into and stunned in a stunning apparatus, but of course several heads of cattle can also be handled at a time. The stunning apparatus can be a CO₂ apparatus, an electric stunning apparatus or a shooting box.

According to the present invention a flock of animals is divided into groups of a prearranged size. As the behaviour of the animals cannot be predicted, the arrangement and method of the invention should preferably be designed to handle groups, which comprise one more animal than the prearranged group size. Of course they shall also be able to handle groups which are short of one or several animals in proportion to the prearranged group size and which contain as few as one animal, e.g. when the flock is incomplete. By a prearranged group size of e.g. 5 the space conditions and process times shall therefore preferably be able to tolerate a group of 6 animals, in order that the arrangement and the well-being of the animals do not become inoperative because an extra animal is allowed into the group by the division or because a flock that is to be divided into three contains more than 15 animals. By dividing a flock of 15 animals into two there must necessarily be a group of 7 animals and a group of 8 animals in each, and also here the arrangement should preferably be tolerant to groups of at least 9 animals.

The invention is described in further detail in the following with reference to the drawing, which shows an embodiment of a system for division of a flock of slaughter pigs into groups and transfer of a group to a stunning apparatus for group wise stunning of the animals.

The drawing shows a driving corridor 1 for driving animals forwards from pens to the system, which comprises an arrangement 2 for division of the animals into groups of 7-8 animals and a stunning apparatus 3 for group wise stunning of the animals (e.g. from Butina ApS, Denmark). After the stunning process, the animals fall out on a discharge belt 4 and are chained by means of an elevator 5.

The arrangement 2 for division of the animals into groups comprises an oblong corridor section 10 with a sliding gate 11 at the entrance. A sliding division gate 12 is placed ⅔ down the corridor section, which by means of the gate can be divided into an upper corridor sector 10a with room for 15 animals as a standard, and a lower corridor sector 10b with room for a group of animals of 8 individuals as a standard. The division gate 12 can be fully opened and closed, and it can also take up a partially open position, in which there is sufficient room for the animals to pass one by one through the gap, but not sufficient room for two animals side by side to pass at the same time. The exit end of the corridor section is provided with an exit sliding gate 13.

At the corridor sector 10b a gate device is mounted with a travelling sliding gate 14. It can for instance be of the design described in the Danish patent application PA 2002 00466 “Arrangement and method for driving animals forwards in an oblong corridor section” (Slagteriernes Forskningsinstitut). In the shown situation, the travelling sliding gate 14 takes up the position which is shown by a full-drawn line, but it can also take up a number of other positions, three of which are shown by a dotted line and indicated by the reference numbers 14a, 14b and 14c. One side wall of the corridor section has two gaps adjacent the positions 14a and 14b, through which the travelling sliding gate 14 can pass. When not being used, the gaps in the side wall may be closed by a mechanically driven plate of the same height as the wall, so there is no risk of squeezing the animals. Corresponding plates can be found in connection with the sliding gates 11, 12 and 13.

A travelling elevating gate 15 is mounted at the corridor section 10 and it can travel between a starting position at the entrance end of the corridor section and an end position 15 at the division gate 12.

At the exit end of the corridor section a transfer section 16 has been placed with room for a group of animals of 8 individuals as a standard. The section can be closed off by means of the exit gate 13 and is confined to one side by an elevating gate 17 placed in front of the entrance to the stunning apparatus, and to the other side by a movable wall 18, which can be moved to the side of elevating gate when access to the stunning apparatus is given free and the elevating gate is opened.

Arrows show the horizontal movements of the gates.

The system works in the following way:

From the pen area of the slaughterhouse a flock of animals of approx. 15 slaughter pigs are driven into the driving corridor 1 and towards the entrance to the corridor section 10, where the entrance gate 11 is opened. The animals walk into the corridor sector 10a and towards the division gate 12, which is closed, if the corridor sector 10b is not ready to receive animals. The entrance gate 11 is closed when all of the animals in the flock have passed it. When the corridor sector 10b is ready to receive animals (which can happen already before all of the animals are in the corridor sector 10a), the division gate 12 is opened partially so that one animal at a time can pass into the corridor sector 10b. When the division gate is open in this position and the entrance gate 11 is closed, the travelling elevating gate 15 can be run forwards in the corridor section 10 from its starting position at the entrance end of the corridor section, whereby the animals are driven forwards and enter corridor sector 10b one by one.

When a group of animals of 7-8 individuals have entered corridor sector 10b, which is closed in the remote end by the exit gate 13, the division gate 12 is fully closed. The travelling elevating gate 15 stops when it has reached the middle of corridor sector 10b to avoid squeezing of the animals. There are now a group of animals in sector 10b and a group of animals in the foremost half of sector 10a.

The travelling sliding gate is moved from position 14b to position 14c inside the corridor section. When the transfer section 16 is ready to receive a group of animals, the exit gate 13 is opened and the travelling sliding gate 14 is moved forwards in corridor sector 10b, causing the group of animals to walk/be driven into the transfer section 16. The travelling sliding gate stops immediately in front of the position of the exit gate 13 in its closed state. The exit gate 13 is closed. There are now a group of animals in the transfer section 16.

The division gate 12 is opened completely to allow the group of animals in the foremost part of sector 10a to walk into corridor sector 10b. The travelling elevating gate 15 is started again, so that the animals are driven forwards and into corridor sector 10b. If desired, the opening of gate 12 can take place already when the travelling sliding gate starts from position 14b towards position 14c.

The travelling sliding gate 14 is moved to the position 14a outside the corridor section and further on to the position 14b, which processes can be started when the exit gate 13 has been closed.

The travelling elevating gate stops immediately in front of the position of the division gate 12 in its closed state, and the division gate is closed, whereby a group of animals has been isolated in the sector 10b. The travelling sliding gate is moved to position 14c in front of the gate 12 inside the driving corridor.

The travelling elevating gate 15 is returned to its starting position at the entrance end of the corridor section, after which the entrance gate 11 can be opened to allow a new flock of animals to enter the sector 10a from the driving corridor 1. The gate 11 can, if wanted, be opened already when the division gate 12 is closed. In this case the travelling elevating gate shall return to its starting position with the gate lifted in order to avoid collision with animals walking in the sector 10a. When the travelling elevating gate has reached its starting position the gate will be lowered again. The division process is started again by closing the gate 11, partially opening the division gate 12, and driving animals forwards by means of the travelling elevating gate when the sector 10b is released.

The gate device can instead of a travelling elevating gate have a travelling sliding gate of a design similar to the travelling sliding gate 14, so that the animals remain calm during the return of the travelling sliding gate.

When the stunning apparatus 3 is ready to receive a group of animals, the group in the transfer section 16 is driven into a box in the stunning apparatus. The elevating gate 17 is opened and the movable wall 18 is moved towards the position of the elevating gate. When the animals have entered the box, the elevating gate is closed and the movable wall returns to its starting position, after which the transfer section 16 is ready to receive the animals, which already have been or will be isolated in the sector 10b.

The animals are driven into the area 16 in the same way as the previous group of animals, the gate 13 being opened and the travelling sliding gate 14 being moved forwards, whereby the sector 10b is gradually emptied for the new animals in the sector 10a. When the travelling sliding gate 14 has reached the position at the gate 13, this is closed so that the animals are isolated in the area. They are led into a stunning box when this is ready to receive the group.

The driving-in of the animals into a box in the stunning apparatus takes place fairly independently of the division and driving process in the corridor section 10, which gives a high flexibility and improves the capacity of the system. The division of a flock of animals from the pen area into groups, and the driving-in of the groups into the stunning apparatus, can be done over and over again as continuous processes which can be carried out parallel with and relatively unimpeded by each other.

After stunning in the CO₂-atmosphere of the apparatus the animals fall out onto the discharge belt 4, from where they are chained by means of the elevator 5 for subsequent sticking and further processing in the slaughterhouse.

1. Arrangement for division of animals into groups and transfer of groups of animals to a stunning apparatus (3), comprising an oblong corridor section (10) in which animals can be driven from an entrance end to an exit end, which gate is placed in such a way that the corridor area (10b) between the division gate and the exit end has room for a number of animals corresponding to the group size, and a transfer section (16) provided in continuation of the corridor section (10) at the exit end of the section which transfer section has room for a number of animals corresponding to the group size, and which section has a connection with the entrance to the stunning apparatus.

2. Arrangement according to claim 1, wherein the transfer section (16) is placed directly between the exit end of the corridor section and the entrance to the stunning apparatus.

3. Arrangement according to claim 1, wherein the transfer section (16) has a rectangular shape with a short side placed opposite the exit end of the corridor section (10) and a long side placed opposite the entrance to the stunning apparatus.

4. Arrangement according to claim 3, wherein the transfer section (16) has a movable wall (18) at the other long side, which wall can be moved over to the long side opposite the entrance to the stunning apparatus.

5. Arrangement according to claim 1, wherein an access gate (13) is placed at the entrance of the transfer section from the corridor section (10).

6. Arrangement according to claim 1, further comprising a gate device, placed at the corridor section (10), with a traveling sliding gate (14) or a traveling elevating gate which can be moved in the corridor area (10b) from the entrance end to the exit end and can return with the gate withdrawn from or elevated above the corridor section.

7. Arrangement according to claim 6, wherein an access gate (13) is placed at the entrance of the transfer section from the corridor section (10) and the traveling sliding/elevating gate can be moved from a position at the division gate (12) to a position at the access gate (13).

8. Arrangement according to claim 7, wherein the gate device has the traveling sliding gate and comprises a first transport mechanism to pull the traveling sliding gate (14) sideways out of the corridor section (10) and push it sideways into the corridor section through gaps in one side wall of the corridor at the access gate (13) and the division gate (12), respectively, and a second transport mechanism to move the traveling sliding gate (14) in the a longitudinal direction of the corridor section from a starting position (14c) in front of the division gate (12) to an end position at the access gate (13), and to move the traveling sliding gate (14) back outside the corridor section, after it has been pulled sideways out of the corridor section (10), from a position (14a) which is opposite the end position at the access gate and to a second position (14b), which is opposite the starting position (14c) in front of the division gate (12).

9. Arrangement according to claim 8, wherein the first transport mechanism comprises a guide device, in which the traveling sliding gate (14) is displaceable mounted so that the gate, by means of a motor, can be displaced out of the corridor through a gap in one side wall of the corridor at the access gate (13), from a position in the corridor section to a position (14a) outside the section, and can be moved in the opposite direction into the corridor through a gap in the same side wall of the corridor at the division gate (12), and the second transport mechanism is connected with the guide device and the motor in such a way that it can transport these and the traveling sliding gate (14) in the longitudinal direction of the corridor section.

10. Arrangement according to claim 1, wherein the division gate (12) can be opened partially to a position, which allows animals to walk one by one through the passage formed in the corridor section (10) by the opening process, and the gate (12) can also be opened completely to form an opening of the same width as the corridor section, which opening allows several animals to be driven next to each other by means of a driving device.

11. Arrangement according to claim 1, wherein the corridor area (10a) of corridor section between the entrance end and the division gate (12) has room for a flock of animals of the size that is wanted to be divided into groups.

12. Arrangement according to claim 1, further comprising a driving gate (15), which can be moved in the longitudinal direction of the corridor section between a starting position at the entrance end of the corridor section and to a position at the division gate (12), such as a traveling sliding gate or a traveling elevating gate.

13. Arrangement according to claim 1, further comprising an entrance opening at the entrance end of the corridor section by one of the long side walls of the corridor section (10), which opening can be closed by means of a gate (11).

14. Arrangement according to claim 1, further comprising a stunning apparatus.

15. Method for division of animals into groups and transfer of groups of animals to a stunning apparatus (3),
a) driving animals in an oblong corridor section (10) from an entrance end towards an exit end and past an open division gate (12), which is placed between the entrance end and the exit end, the division gate being placed in such a way that the corridor area (10b) between the division gate (12) and the exit end has room for a number of animals corresponding to the group size,
b) closing the division gate (12) when a number of animals corresponding to the group size have passed,
c) driving the group of animals into a transfer section (16), placed in continuation of the corridor section (10) at the exit end of the section when the transfer section (16) is ready to receive a group of animals, which transfer section has room for a number of animals corresponding to the group size and has connection with the entrance to the stunning apparatus,
d) closing the access from the corridor section (10) to the transfer section (16),
e) driving the group of animals in the transfer section (16) into the stunning apparatus (3) when this is ready to receive a group of animals, and
f) repeating the process steps a) to e) as long as there are animals in the corridor area (10a) between the entrance end and the division gate (12), the division gate (12) being opened between each cycle.

16. Method according to claim 15, and wherein the transfer section (16) has a rectangular shape with a short side placed opposite the exit end of the corridor section (10) and a long side placed opposite the entrance to the stunning apparatus, and further comprising moving a movable wall (18) at the other long side over to the long side placed opposite the entrance to the stunning apparatus in connection with process step e).

17. Method according to claim 15, further comprising driving animals in the corridor area (10b) between the division gate and the exit end by means of a gate device with a traveling elevating or traveling sliding gate and returning the elevating/sliding gate with the gate pulled out of or elevated above the corridor section.

18. Method according to claim 15, further comprising partially opening the division gate (12) to a position which allow animals to walk one by one through the passage formed by the opening process when the number of animals on the corridor area (10a) between the entrance end and the division gate exceeds the number of animals in a group.

19. Method according to claim 15, further comprising partially opening the division gate (12) to a position which allows animals to walk one by one through the passage formed by the opening process when the number of animals on the corridor area (10a) between the entrance end and the division gate exceeds the number of animals in a group.

20. Method according to claim 15, further comprising driving animals on the corridor area (10a) between the entrance end and the division gate forwards by means of a traveling elevating or traveling sliding gate.
